(19) United States
(12) Patent Application Publication
(10) Pub. No.: US 2010/0226825 A1
(43) Pub. Date: Sep. 9, 2010

(54) Smart pipette with sensor in tip

(76) Inventors: Samuel Beckey, Half Moon Bay, CA (US); Joseph Fanelli, Escondido, CA (US); Alan Waldman, Oceanside, NY (US)

Correspondence Address: CATALYST LAW GROUP, APC, 9710 SCRANTON ROAD, SUITE 280, SAN DIEGO, CA, 92121, US

(21) Appl. No.: 12/652,627

(22) Filed: Jan. 5, 2010

Related U.S. Application Data
(60) Provisional application No. 61/204,315, filed on Jan. 5, 2009.
(60) Provisional application No. 61/204,313, filed on Jan. 5, 2009.

(51) Int. Cl. B01L 3/02

(52) U.S. Cl. 422/100

(57) ABSTRACT

The present invention relates to a pipette. More specifically, the invention relates to systems and methods for using the pipette. The pipette and system includes technological advancements which improve quality control and accuracy in pipetting operations.

### RELATED APPLICATIONS

This application claims the benefit of priority to U.S. provisional application Ser. No. 61/204,315, filed Jan. 5, 2009, and U.S. provisional application Ser. No. 61/204,313, filed Jan. 5, 2009. The disclosures of the above referenced applications are incorporated by reference in their entireties herein.

### FIELD OF THE INVENTION

This application relates to a pipette. More specifically, the invention relates to systems and methods for using the pipette.

### BACKGROUND OF THE INVENTION

Pipetting is a familiar operation and fundamental to most chemistry and biological laboratories. Pipettes are used for measuring or dosing liquids. Pipettes operate using a movable piston which can be operated either manually or electrically. While automated liquid handling systems have been available for some time, manual pipettes continue to play an important role in the lab because of their flexibility and familiarity.

Pipettes have also been produced, using electronics to improve accuracy and reduce manual labor, especially in terms of repetitive motions. A laboratory worker routinely performs dosing operations repeatedly throughout the work day. A number of references have tried to improve the ergonomics of pipetting. However, any process that is repeated manually several times is subject to human error.

Errors in laboratory procedures often are caused by mistakes in pipetting operations. Accessing the wrong reagent, dispensing in a nearby well, repeating an operation, or skipping an operation are all common, especially when a protocol could call for thousands of manual operations.

Meanwhile, various enhanced devices are being created for other fields with increasing technological capabilities. These capabilities include, embedded computing, improved communications, as well as imaging and recording features built into the devices of any form factor.

Record keeping requirements in laboratories have also increased in importance recently. In a laboratory it is desirable that processes be self documenting, and that deviations be automatically detected and recorded. In clinical diagnostic labs, validation of operating procedures can be enhanced with machine generated records.

Pipette tips with sensors have been used in specific applications before, especially in robotic diagnostic and laboratory automation. Treptow et al., (U.S. Pat. No. 5,844,686) describes a photometric sensing capability in a pipette.

A handheld pipette which places computer technology into the device for moving liquids in a diagnostic procedure or experiment is desirable to improve quality control and accuracy. The typical use of the device is to accurately manage the operation of the pipette itself, calibrating the movement of a piston such that operations are precise and require limited physical effort from the user. The present invention is unique in providing a handheld pipette with enhanced technological capabilities making it a “smart” pipette.

### SUMMARY OF THE INVENTION

It is therefore an object of this invention to combine techniques used in automated liquid handling with some new features to create a handheld smart pipette and system with unprecedented new capabilities.

One aspect of the present invention is a handheld smart pipette, which combines an electronics and fluidics package.

In yet another aspect of the invention the smart pipette provides for an automated piston operation for aspirating and dispensing.

In another aspect of the present invention the smart pipette may have a user interface with multiple dispense volumes.

In still another aspect of the invention the smart pipette provides user feedback for error and warning conditions.

In another aspect of the invention the smart pipette has an authentication and authorization via a user login.

In another aspect of the invention the smart pipette has a position recording function for all operations.

Accordingly, another aspect of the invention is the addition of position information to the smart pipette.

In another aspect of the invention is the smart pipette system provides for media and container identification.

In still another aspect of the invention the smart pipette has internal calibration with sample liquids.

In another aspect of the invention the smart pipette provides for work instruction delivery to the user.

In another aspect of the invention the smart pipette has the capability to record user operations.

Another aspect of the invention is a method for information processing, creating and storing secure records of pipette operations.

In still another aspect of the invention the smart pipette is able to wirelessly transmit information to a workstation.

In another aspect of the invention the smart pipette performs measurements in the pipette itself.

Another aspect of the invention provides for the pipette tip, which is often a replaceable, disposable plastic device can include sensors which perform measurements on the liquid or sample being transferred or held in the pipette.

Accordingly, another aspect on the invention is utilizing a smart pipette as a diagnostic tool for certain diseases.

In another aspect of the present invention the handheld pipette, is supplemented with a workstation which includes position feedback capabilities.

### BRIEF DESCRIPTION OF THE DRAWINGS

For a better understanding of the invention as well as other objects and further features thereof, reference is made to the following detailed description of various preferred embodiments thereof taken in connection with the accompanying drawings wherein:

FIG. 1 is a schematic representation of a workstation for use with the smart pipette. Shown are examples of media and fixtures, which may be modified to suit the application.

FIG. 2 is a smart pipette design according to the present invention.

### DETAILED DESCRIPTION OF THE INVENTION

One aspect of the invention is a smart pipette which can accurately record the location of its aspiration and dispense operations. The smart pipette used in conjunction with a workstation creates a system and method for accurate performance of pipetting operations on each well of any media located on the workstation.

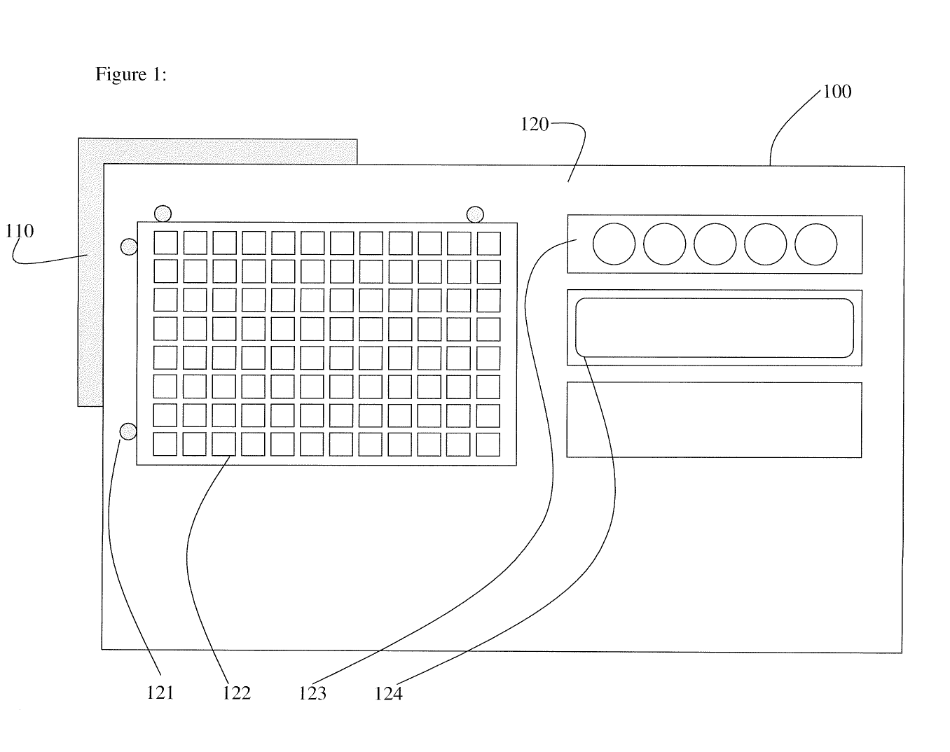

Referring now to FIG. 1, a workstation is shown which can be used in conjunction with the smart pipette. Important concepts are shown, such as media which can represent a various number of pipetting locations, or wells. A small working area 100 allows convenient arrangement of items to be worked with. This space can be installed on a benchtop, or can be the benchtop itself.

An electronic module 110 is affixed to the working surface. This module allows the location in two or three dimensions of a passive electronic coil 280 which is affixed to the smart pipette 200. This capability is already well understood in other applications, such as electronic white boards and various digitizer tablets.

Guideposts 121 or equivalent are installed on the working surface to positively locate various media. In the example a microtitre plate 122 with 96 well is shown. Commonly available plates allow up to 1536 wells or higher. Also shown is a tube rack 123 which would typically be used to hold reagent vials. A wash station 124 is also shown. It is within the scope of the present invention that a workstation can be any type of workstation typically found in a laboratory.

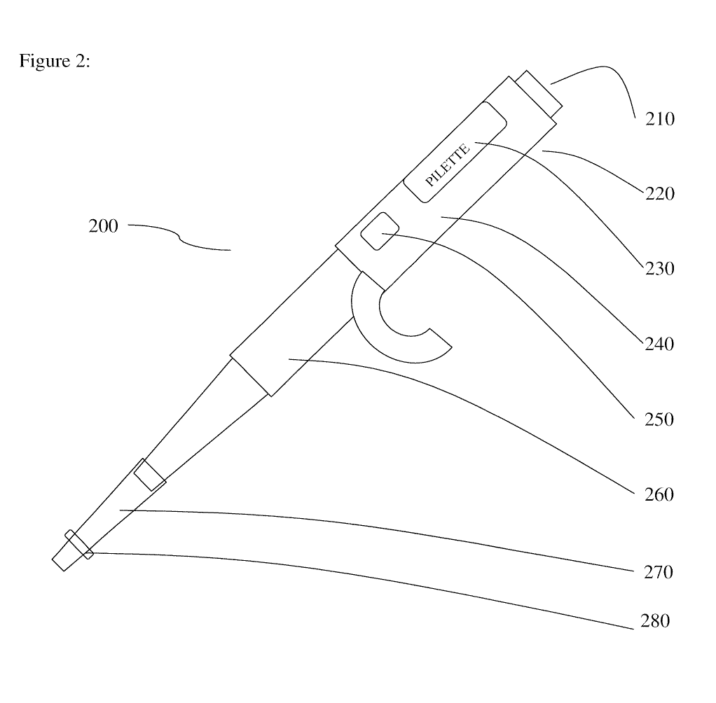

Referring now to FIG. 2, a conceptual smart pipette design is given. The smart pipette 200 has a number of notable features. In this conceptual model, a small low impact pushbutton 210 is used to operate the pipette. Depending on the operation selected with a button 250 and shown on the display 230 the button will aspirate or dispense a previously selected amount. The casing around the electronics module 240 provides a convenient handhold and is preferably designed to ergonomic standards.

The piston operated pump housed in casing 260 moves liquids by displacement. The pump is designed for high precision operations, and is controlled by electronics in the electronics module 240. The electronics compensates for friction and latency in the movement of the piston according to calibration and control algorithms including PID control located in the electronics module 240.

A removable and disposable tip 270 is attached to the pump casing 260. Commonly available tips are accommodated, and tips can be changed to operate the smart pipette with a range of volume capabilities.

Accordingly, another aspect of the invention is the addition of position information to the smart pipette. The “Position Aware” smart pipette in combination with its fixture, allows the pipette to prevent operational errors. These errors are an important cause of erroneous results. The smart pipette uses position transducers to detect its location in the X, Y, (and optionally Z) dimensions. If the fixture locates containers and media (titration plates, vials, etc.) in fixed specified locations, the smart pipette can verify that the correct operations according to the protocol are being performed. In the event an error is made, the pipette can: (a) make a record of the error, (b) verify with the operator that they are certain of the operation the are performing, or (c) refuse the operation; or the smart pipette can perform any combination of the previous functions.

Another aspect of the invention is a method for information processing, creating and storing secure records of pipette operations. Unique to the invention the smart pipette has an inductive ring 280 which is physically attached to the tip at a location near the end. This ring, which is easily replaceable is used by the workstation module 110 to establish the two or three dimensional location in physical space as related to the workstation. The information from the workstation electronics module is recorded, wither in the smart pipette itself, or in a computer controller at the moment when each aspiration or dispense operation is performed. The volume moved is also recorded. It is within the scope of the invention that the inductive ring 280 can be affixed or attached to any pipette typically found in a laboratory in order to interact with the workstation.

In another aspect of the invention the smart pipette has an authentication and authorization via a user login. In order to accommodate record keeping requirements, the smart pipette will further be enabled to request and receive log-in information from the user. The smart pipette software will include security and authorization information along with its record of operations.

In another aspect of the invention is the smart pipette system provides for media and container identification. Identification of reagents in the setup of the workstation and during operations will be accomplished through automated and manual means. The smart pipette may include a barcode reader, or a similar device, and such as device may be incorporated with the workstation component.

The electronics module of the smart pipette, consisting of the upper portion 250, 240, 230, 220, 210 is designed to be removed from the mechanical portion 260 allowing all components potentially in contact with experimental liquids to be adequately cleaned and potentially autoclaved.

In another aspect of the invention the smart pipette provides for work instruction delivery to the user which will be accomplished by the Smart Device Program. The smart pipette may be capable of passively recording operations, or may also have the capability to record a protocol and prompt the user as necessary to perform the established protocol. For example, the pipette could be downloaded with protocol steps, such as “Obtain 200 μL of Reagent XYZ and place in location A”, “Obtain a new microtitre plate a locate on the workstation”, “Aspirate 50 μL from location A”, and “Dispense 10 μL to each of locations A1 through A3 on the plate”.

The amount dispensed for each of the operations in the above example could be automatically set by the protocol for the pipette so that the user interface would only be used to confirm the operation to the user. In addition, if the user attempted to dispense or aspirate from an erroneous location, the smart pipette could warn the user, or even prevent the operation.

In another aspect of the invention the smart pipette has internal calibration with sample liquids. Calibration can be aided in the smart pipette by using the location information and protocol definition to incorporate feedback into the pipette operation. The protocol could verify calibration before and/or after operation by adding steps to the protocol itself. The workstation fixture can be set up to facilitate calibration by including reference standard fluids, and a further calibration feedback mechanism. Accurate measurements of dispense volume can be accomplished in the workstation by measuring a quantity describing a standard liquid: this could be mass, bead counts, radiological emissions, optical properties, or another mechanism.

In PCT published patent application serial number PCT/US08/72383), incorporated herein by reference, we describe voice enabled smart software for lab management (EVELyN). The present invention could integrate with the voice enabled smart software to provide a voice prompted working environment, bi-directionally with the user.

Pipette tips that are manufactured via a polymer that has certain metal ions in the injection molding polymeric mixture to achieve a conductivity threshold measurement, i.e., conductivity=liquid meniscus=tip/liquid contact if the pipetting protocol requires liquid delivery at the meniscus, which it sometimes does

−zero conductivity=no liquid contact

The design of the tip can contain a coil or metal ions to determine where in a magnetic field the tip is positioned (equal to a specific micro titre plate well #) or over a 2D grid that can detect the tip via some means such as a mini GPS field set up over or under the micro titre plate (this locator feature is high value since the most frequent manual liquid handling error is delivery of liquid into the wrong well).

The electrical contacts form a tapered barrel know when the tip is “locked” in place, or it won't pipette. Faulty tips that cannot pull a vacuum around the tapered barrel are also a source of volumetric error and are detected.

Binding events, using a coated material in the type can be detected electronically. Depending on the material a means to bind selectivity, based on the type and nature of the coating or impregnated material, enables measurement of specific liquid properties.

Another aspect of the invention provides for the pipette tip, which is often a replaceable, disposable plastic device can include sensors which perform measurements on the liquid or sample being transferred or held in the pipette.

Accordingly, the electrical interface in the tip provides a means to enable analytical measurements based on active binding, presence of metal ions, change in conductivity, reaction rates, etc., selectively or generally.

The electrical interface to the tip provides a means to detect specific changes in conductivity or electrochemical properties such that it can detect that binding has occurred relative to total analyte concentration (bound vs. free) in the presence of or absence of a specific reagent.

Multiple sensors in the tip can detect multiple measurements about a sample. It is possible to provide a means for various tip ranges and concentrations such that one can achieve a panel diagnostic menu with one patient sample. Characteristics of the tip itself, such as coatings, sensors, volume characteristics, and tip shape can be encoded electrically and verified by the smart pipette during operation.

Typically a pipette is used in a sequence of operations: aspirate, dispense, mix, wash. There can be many combinations of these operations which make up a protocol (like a recipe) that is followed and needs to be strictly adhered to. As a result of a series of operations, a sample is prepared which then might go on to other steps, such as incubation and an electrical or optical readout. The sensors in tip allows the pipette itself to perform the readout function. In simple protocols, the sensor could be used to measure the result of the experiment. For example in electrochemical assays, the resistance of the liquid is measured. In Optical assays, a colormetric (spectrographic) result can be obtained. The sensors in the tip allows results to be measured directly by the pipette itself. This feature is advantageous in that it removes an additional instrument and its associated fixtures and media from the process. This feature can also provide benefits in repeatability as the tip itself is constant. The sensor improves timeliness in that readouts can be obtained immediately on mixing and efficiency because no additional sample preparation is needed. A secondary benefit is that the sensors in the tip allow for ongoing quality control and error checking during pipetting operations, since it can be used to make ongoing checks of the sample.

Accordingly, another aspect on the invention is utilizing a smart pipette as a diagnostic tool for certain diseases.

Specific tips can be created for diagnostics for certain diseases. For example, an HIV tip might determine, quantitatively, the viral burden via a range of sensors (or multiple tips), independent of sample concentration of virus, and a micro-conductivity measurement system.

Additional disease specific uses herpes panels (multiple tests with one sample, using multiple pipettes), hepatitis and so on. Many other medical diagnostics currently performed in labs are possible to create in the smart pipette with a tip that contains appropriate sensors.

### Definitions

With respect to ranges of values, the invention encompasses each intervening value between the upper and lower limits of the range to at least a tenth of the lower limit's unit, unless the context clearly indicates otherwise. Moreover, the invention encompasses any other stated intervening values and ranges including either or both of the upper and lower limits of the range, unless specifically excluded from the stated range.

Unless defined otherwise, the meanings of all technical and scientific terms used herein are those commonly understood by one of ordinary skill in the art to which this invention belongs. One of ordinary skill in the art will also appreciate that any methods and materials similar or equivalent to those described herein can also be used to practice or test this invention.

The publications and patents discussed herein are provided solely for their disclosure prior to the filing date of the present application. Nothing herein is to be construed as an admission that the present invention is not entitled to antedate such publication by virtue of prior invention. Further the dates of publication provided may be different from the actual publication dates which may need to be independently confirmed.

All the publications cited are incorporated herein by reference in their entireties, including all published patents, patent applications, literature references, as well as those publications that have been incorporated in those published documents. However, to the extent that any publication incorporated herein by reference refers to information to be published, applicants do not admit that any such information published after the filing date of this application to be prior art.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

We claim:

1. A pipette comprising an electronics module wherein the electronics module is capable of relaying pipetting information.

2. The pipette in claim 1 where in the electronics module is at least a single inductive coil.

3. A pipette system comprising;
a pipette;
a workstation;
wherein said pipette and said workstation interact to determine position orientation information.

4. The pipette system in claim 3 wherein the system can deliver work instructions to the user and configure the pipetting operation for specific protocol steps.

5. The pipette system in claim 3 where in a calibration can be obtained by measuring actual versus expected amount dispensed.

6. A smart pipette with a removable or disposable tip wherein the removable or disposable tip contains at least a single sensor.
